(19) United States
(12) Patent Application Publication
(10) Pub. No.: US 2025/0305610 A1
(43) Pub. Date: Oct. 2, 2025

(54) Compact End Fitting Assembly For Composite Pipe

(71) Applicants: Chevron U.S.A. Inc., San Ramon, CA (US); Saipem S.A., Montigny Le Bretonneux (FR)

(72) Inventors: Antonio Critsinelis, Kingwood, TX (US); Edward Nakajima, San Ramon, CA (US); Jason Robert McClure, San Ramon, CA (US); Raymond Hallot, Montigny Le Bretonneux (FR)

(21) Appl. No.: 18/863,999

(22) PCT Filed: May 11, 2022
(86) PCT No.: PCT/US2022/028731

§ 371 Date: Nov. 7, 2024

(51) Int. Cl. F16L 33/22; F16L 39/02

(52) U.S. Cl. CPC F16L 33/222; F16L 39/02

(57) ABSTRACT

An end fitting assembly for a pipe-in-pipe assembly comprises a socket portion, a connector portion extending from the socket portion, a stop located between the socket portion and the connector portion, a collar that fits around the socket portion and attaches to the stop, and a wedge that fits between the collar and an inner composite pipe. When the collar is pushed onto the wedge, a series of collar cone sections engage a series of wedge cone sections causing a compression force on the inner composite pipe. The collar and the wedge are shaped so that they fit within an outer pipe of the pipe-in-pipe assembly. The compact shape of the collar and wedge facilitate reeling the pipe-in-pipe assembly onto a reel without causing excessive stress in the pipe-in-pipe assembly.

### TECHNICAL FIELD

Embodiments of the technology relate generally to end fitting assemblies for composite pipe and pipe-in-pipe assemblies.

### BACKGROUND

Pipelines are commonly used to transport fluids, including water, gasses, and hydrocarbon products. The pipe components used in a pipeline can be made from a variety of materials including various types of steel. More recently, pipes made from plastics and composites, which are referred to as engineered pipes, thermal composite pipes, or composite pipes, are becoming more common for the transport of hydrocarbons. Composite pipes can be fabricated in a number of different configurations and can consist of a single layer or multiple layers. Materials used to form composite pipes can include various combinations of materials, such as thermoplastic, plastic, elastomers, carbon fiber, polymeric compounds, fiber glass, ceramic compounds, steel portions, and the like. While traditional steel pipes provide desirable characteristics such as strength and durability, composite pipes can offer other benefits with respect to maleability, corrosion and erosion resistance, lighter weight, and thermal insulation.

In subsea hydrocarbon production, pipelines, including risers, flowlines, and jumpers, are often used to convey hydrocarbons and other fluids from subsea wells to vessels and facilities at the water's surface or onshore. Given the engineering challenges associated with subsea hydrocarbon production systems, pipe configurations and material are selected to satisfy several objectives, including flow assurance, corrosion resistance, thermal insulation, pressure containment, temperature resistance, on-bottom stability, operating flexibility, reliability, and ease of fabrication and installation. Achieving these objectives can assist in maintaining high availability with steady production, while mitigating failures, blockages, and unplanned production shut-downs.

Sections of steel pipe are typically joined at their terminations with welds (pipe to pipe, pipe to connector, or pipe to equipment). In contrast, due to the complexity of their structure, composite pipes typically have more complex end fittings. The end fitting of a composite pipe can act as a housing to wrap, secure, anchor, and/or seal the layers of the composite pipe, while providing strength for pressure, temperature, thermal loads, installation loads and corrosion resistance. Additionally, the end fitting of a composite pipe can provide an interface connection with other interfacing components, pipe sections, subsea structures, topside piping, and/or testing equipment.

One application for composite pipe involves inserting the composite pipe within a wider outer pipe. An assembly that includes a relatively narrow pipe inserted into a wider outer pipe is commonly referred to as a pipe-in-pipe assembly. When a composite pipe is inserted into a wider outer pipe, the assembly can be referred to as an “engineered composite in pipe” (“ECIP”). ECIPs are described in greater detail in U.S. Pat. No. 9,303,795, however, given the broad applicability of the solutions described herein, this disclosure will refer more broadly to pipe-in-pipe assemblies and the inner pipe of such assemblies will be referred to broadly as a composite pipe. The wider outer pipe of such pipe-in-pipe assemblies can be steel pipe as it is typically desirable for the wider outer pipe to be more rigid than the inner pipe. Pipe-in-pipe assemblies that use steel pipe as the outer pipe are advantageous because they combine the properties of composite pipe for the inner pipe with the strength and durability of steel for the outer pipe and the ability to have higher thermal insulation capabilities. However, the foregoing described challenges with end fittings for composite pipe can be compounded in a pipe-in-pipe assembly because the end fitting must facilitate joining both the inner composite pipe as well as the outer pipe to another pipe or some other structure. Other challenges that must be considered relate to fabrication of the pipe-in-pipe assembly as the inner composite pipe is often a spooled product supplied on a reel. Accordingly, pipe-in-pipe assemblies with an inner composite pipe that have an improved end fitting assembly would be beneficial for enabling a more compact pipe-in-pipe configuration and easy assembly process. The following description explains the shortcomings of existing end fittings for composite pipe and then provides example embodiments for improved end fitting assemblies that are more compact than conventional end fittings.

### SUMMARY

In one example embodiment, the present disclosure is generally directed to an end fitting assembly for a composite pipe. The end fitting assembly can comprise: (i) a socket portion having a cylindrical shape and comprising a socket internal surface and a socket external surface, the socket portion configured to fit within an end of the composite pipe; (ii) a connector portion having a cylindrical shape and comprising a connector internal surface and a connector external surface, the connector portion extending from the socket portion; (iii) a stop located between the socket external surface and the connector external surface; (iv) a collar that attaches to the stop, the collar having a cylindrical shape; and (v) at least two wedges that are positioned between an external surface of the composite pipe and a collar internal surface, wherein each wedge of the at least two wedges comprises a series of wedge cone sections along an outer surface of the wedge, and wherein the collar internal surface comprises a series of collar cone sections.

The foregoing example embodiment can include one or more of the following elements. The collar can have a constant outer diameter such that an outer diameter of the collar is less than an inner diameter of an outer pipe when the composite pipe and outer pipe are formed into a pipe-in-pipe assembly. The end fitting assembly is configured such that it can attach to any of: another end fitting assembly, a bulkhead, and a flowline end termination. The collar and the at least two wedges are fitted around the external surface of the composite pipe and when the composite pipe is inserted into an outer pipe to form a pipe-in-pipe assembly, an external surface of the collar is parallel to an internal surface of the outer pipe of the pipe-in-pipe assembly. The at least two wedges can surround the external surface of the composite pipe. When the collar is moved toward the stop and the connector portion, the collar cone sections compress the wedge cone sections thereby compressing the composite pipe. When a clamping force is applied to the collar a thick cone end of each collar cone section is moved toward a thick cone end of each wedge cone section. The collar can be attached to an outer circumferential surface of the stop by one of: a weld, a dowel, and threads.

In another example embodiment, the present disclosure is generally directed to a pipe-in-pipe assembly comprising an end fitting assembly. The pipe-in-pipe assembly can comprise: (i) an outer pipe; (ii) an inner composite pipe disposed within the outer pipe; (iii) an end fitting assembly attached to a termination of the inner composite pipe, wherein the end fitting assembly comprises: (iv) a socket portion having a cylindrical shape and comprising a socket internal surface and a socket external surface, the socket portion disposed within the termination of the inner composite pipe; (v) a connector portion having a cylindrical shape and comprising a connector internal surface and a connector external surface, the connector portion extending from the socket portion and the termination of the inner composite pipe; (vi) a stop located between the socket external surface and the connector external surface; (vii) a collar attached to the stop, the collar having a cylindrical shape; and (viii) at least two wedges positioned between an external surface of the inner composite pipe and a collar internal surface, wherein each wedge of the at least two wedges comprises a series of wedge cone sections along an outer surface of the at least two wedges, and wherein the collar internal surface comprises a series of collar cone sections.

The foregoing example embodiment can include one or more of the following elements. The collar can have a constant outer diameter that is less than an inner diameter of the outer pipe. The pipe-in-pipe assembly is configured to attach to one of: another pipe-in-pipe assembly, a bulkhead, and a flowline end termination. When the pipe-in-pipe assembly is attached to another pipe-in-pipe assembly, the pipe-in-pipe assembly and the other pipe-in-pipe assembly can be reeled onto a spool. The at least two wedges can surround the external surface of the inner composite pipe. When the collar is moved toward the stop and the connector portion, the collar cone sections compress the wedge cone sections thereby compressing the inner composite pipe. When a clamping force is applied to the collar a thick cone end of each collar cone section is moved toward a thick cone end of each wedge cone section. The pipe-in-pipe assembly is configured to be attached to a bulkhead, wherein the bulkhead comprises an external port and an internal port providing access to an annulus of the pipe-in-pipe assembly.

In yet another example embodiment, the present disclosure is generally directed to a method of assembling an inner composite pipe and end fitting assembly for use in a pipe-in-pipe assembly. The method can comprise: (i) placing at least two wedge segments along an internal surface of a collar; (ii) sliding the collar with the at least two wedge segments onto an external surface of the inner composite pipe; (iii) inserting a socket portion of an end fitting into a termination of an inner composite pipe of the pipe-in-pipe assembly, the socket portion inserted until a stop of the end fitting engages the termination, the at least two wedge segments, and the collar, wherein the end fitting comprises a connector portion extending from the stop and extending from the socket portion and extending out of the termination of the inner composite pipe; (iv) pushing the collar toward the stop and the connector portion causing the collar to compress the at least two wedges, the collar comprising a series of collar cone sections along a collar internal surface; and (v) securing the collar to the stop.

The foregoing example embodiment can include one or more of the following elements. The foregoing method can further comprise drawing the end fitting and the inner composite pipe through an outer pipe until the connector portion of the end fitting extends from a termination of the outer pipe, wherein the inner composite pipe, the end fitting, and the outer pipe form the pipe-in-pipe assembly. The foregoing method can further comprise reeling the pipe-in-pipe assembly onto a reel. In the foregoing example method, when the collar is pushed onto the at least two wedges, the collar cone sections engage the wedge cone sections thereby compressing the inner composite pipe.

The foregoing embodiments are non-limiting examples and other aspects and embodiments will be described herein. The foregoing summary is provided to introduce various concepts in a simplified form that are further described below in the detailed description. This summary is not intended to identify required or essential features of the claimed subject matter nor is the summary intended to limit the scope of the claimed subject matter.

### BRIEF DESCRIPTION OF THE DRAWINGS

The accompanying drawings illustrate only example embodiments of an improved end fitting assembly for engineered or composite pipe and therefore are not to be considered limiting of the scope of this disclosure. The principles illustrated in the example embodiments of the drawings can be applied to alternate methods and apparatus. Additionally, the elements and features shown in the drawings are not necessarily to scale, emphasis instead being placed upon clearly illustrating the principles of the example embodiments. Certain dimensions or positions may be exaggerated to help visually convey such principles. In the drawings, the same reference numerals used in different embodiments designate like or corresponding, but not necessarily identical, elements.

FIG. 1 illustrates an end fitting assembly and composite pipe as known in the prior art.

FIG. 2 illustrates a cross-sectional view of the end fitting assembly and composite pipe of FIG. 1.

FIG. 3 illustrates a cross-sectional view of a variation of the end fitting assembly and composite pipe of FIG. 1.

FIG. 4 illustrates another end fitting assembly and composite pipe as known in the prior art.

FIG. 5 illustrates a cross-sectional view of the end fitting assembly and composite pipe of FIG. 4.

FIG. 6A illustrates a cross-sectional view of an end fitting assembly and composite pipe with the collar in a first position in accordance with the example embodiments of the present disclosure.

FIG. 6B illustrates a cross-sectional view of an end fitting assembly and composite pipe with the collar in a second position in accordance with the example embodiments of the present disclosure.

FIG. 7 illustrates the ends of two pipe-in-pipe assemblies joined by two end fitting assemblies in accordance with the example embodiments of the present disclosure.

FIG. 8 illustrates two pipe-in-pipe assemblies joined to an intermediate bulkhead by two end fitting assemblies in accordance with the example embodiments of the present disclosure.

FIG. 9 illustrates a pipe-in-pipe assembly and end fitting assembly joined to a transition piece/bulkhead which is joined to flowline end termination structure in accordance with the example embodiments of the present disclosure.

FIG. 10 illustrates two pipe-in-pipe assemblies joined by two end fitting assemblies and bent around a reel in accordance with the example embodiments of the present disclosure.

FIG. 11 illustrates a method of using an end fitting assembly in a pipe-in-pipe assembly in accordance with the example embodiments of the present disclosure.

### DETAILED DESCRIPTION OF EXAMPLE EMBODIMENTS

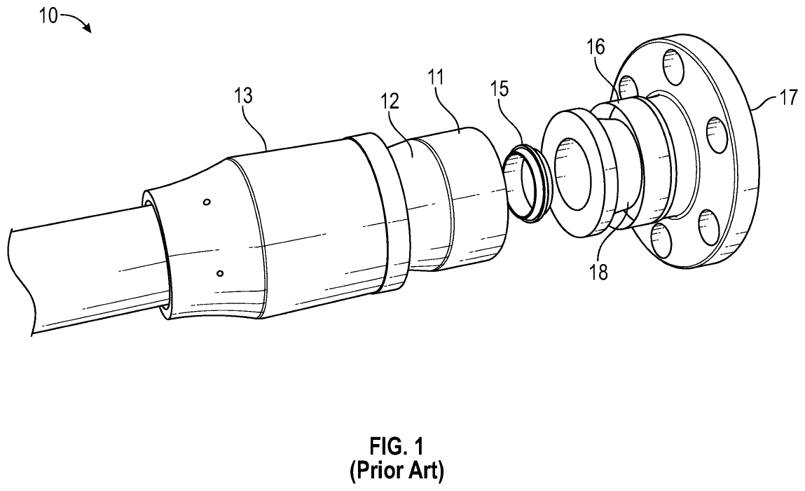

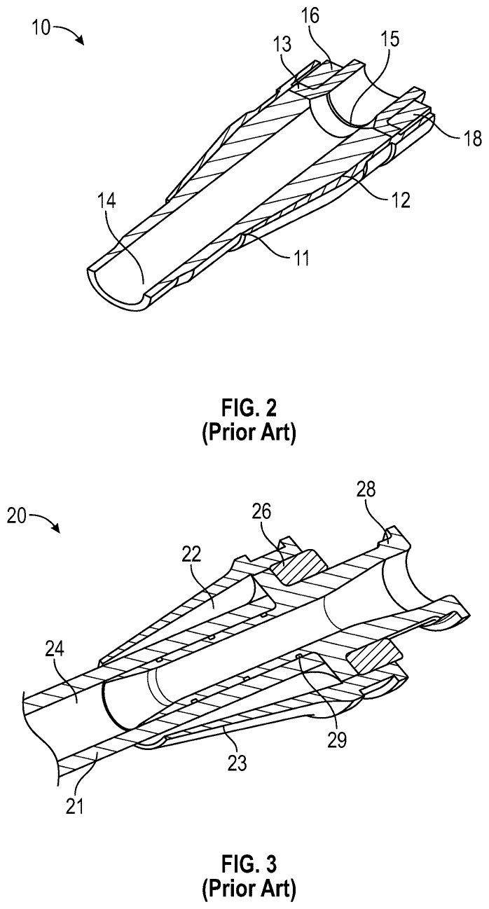

The example embodiments discussed herein are directed to apparatus and methods for an end fitting assembly attached to a pipe-in-pipe assembly. As will be described below and illustrated in the attached figures, the end fitting assemblies of the present disclosure are more compact than prior art end fitting assemblies. The more compact end fitting assemblies of the present disclosure have a smaller diameter and fewer components as compared to prior art end fitting assemblies. For example, the end fitting assemblies of the present disclosure do not require the pipe build-up and locking ring illustrated in the prior art assemblies of FIGS. 1 and 2. The compact end fitting assemblies described herein facilitate use of composite pipe within an outer pipe to form an improved pipe-in-pipe assembly. The more compact end fitting assemblies of the present disclosure provide the housing needed for the end terminations of composite pipes (as described above), while also providing connections to bulkheads, other equipment, and for connecting pipe-in-pipe assemblies together. The compact end fitting assemblies of the present disclosure also allow pipe-in-pipe assemblies to bend for purposes of reeling and spooling lengths of multiple pipe-in-pipe assemblies for transportation and installation, for instance, in subsea locations. Installation of lengths of multiple pipe-in-pipe assemblies using the compact end fitting assemblies can be preferably done by reel lay and towing, but could be applied by any other method, including J-lay or S-lay.

In the following paragraphs, particular embodiments will be described in further detail by way of example with reference to the drawings. In the description, well-known components, methods, and/or processing techniques are omitted or briefly described. Furthermore, reference to various feature(s) of the embodiments is not to suggest that all embodiments must include the referenced feature(s).

FIGS. 1-5 illustrate examples of end fitting assemblies for composite pipe as are known in the prior art. As will be described further in connection with the figures, the prior art end fittings are ill-suited for use in pipe-in-pipe assemblies due to their shape and size. Referring to FIGS. 1 and 2, an example of a prior art end fitting assembly 10 for a composite pipe 11 is illustrated. FIG. 1 shows the end fitting assembly 10 before it is attached to the termination of the composite pipe 11 and FIG. 2 provides a cross-section illustrating the end fitting assembly 10 after it has been attached to the termination of the composite pipe 11. The composite pipe 11 includes an inner liner, referred to as a pipe precursor 14, and a build-up 12 at the termination, the build-up 12 consisting of additional material to facilitate attachment of the end fitting assembly 10. The additional material of the build-up 12 results in the wall of the composite pipe 11 being thicker at the termination and the outer diameter being larger. A seal 15 is placed into the composite pipe 11 followed by end fitting 17. End fitting 17 comprises a hub 18 surrounded by a locking ring 16. After the seal 15 and end fitting 17 are inserted into the composite pipe 11, the collar 13 slides over the build-up 12 and is threaded to the locking ring 16. As can be seen in FIGS. 1 and 2, the outer diameter of the composite pipe 11 with the end fitting assembly 10 increases near the termination due to the build-up 12 and the shape of the collar 13. This wider outer diameter illustrated in FIGS. 1 and 2 at the termination presents challenges for using such an arrangement in a pipe-in-pipe assembly where the composite pipe 11 and end fitting assembly 10 would be drawn through a wider outer pipe. The wider outer diameter of the assembly in FIGS. 1 and 2 may not fit through the inner diameter of the outer pipe in a pipe-in-pipe assembly. Additionally, the wider outer diameter at the termination of the assembly in FIGS. 1 and 2 limits the capacity for bending when placed in a pipe-in-pipe assembly thereby interfering with the ability to reel lengths of multiple pipe sections onto a reel.

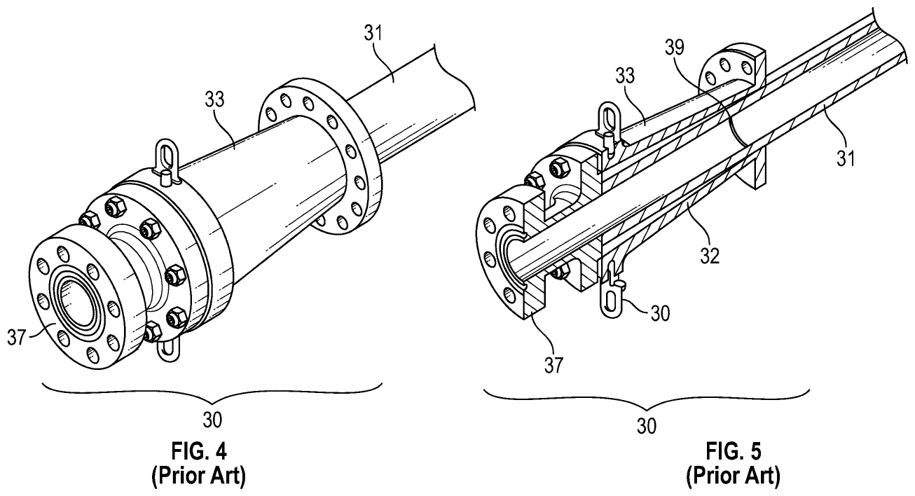

FIG. 3 is a cross-section illustrating another example from the prior art of an end fitting assembly 20 attached to a composite pipe 21. The example of FIG. 3 is similar to the example of FIGS. 1 and 2 in that it uses collar 23 having a widening diameter that threads onto a locking ring 26. Also similar to the previous example, the composite pipe 21 has an inner liner which is referred to as the pipe precursor 24. The example of FIG. 3 differs from the prior example in the following two aspects. First, instead of the build-up of the pipe wall, the example of FIG. 3 uses a collet 22 to expand the outer diameter at the termination of the composite pipe 21. Second, instead of the seal and hub of the previous example, the example of FIG. 3 uses a stab hub 28 that is inserted into the composite pipe 21. The stab hub 28 uses o-rings 29 to form a seal between the outer circumference of the stab hub and the pipe precursor 24. The example of FIG. 3 suffers from the same limitations as the previous example in that when the end fitting assembly 20 is attached to the composite pipe 21, the outer diameter of the entire assembly increases towards the termination of the pipe 21 thereby limiting its usefulness for pipe-in-pipe assemblies.

Referring to FIGS. 4 and 5, another example of a prior art end fitting assembly attached to a composite pipe is illustrated. FIG. 4 illustrates an end fitting assembly 30 attached to a composite pipe 31. The end fitting assembly 30 includes an end fitting 37 and a collar 33 that secures the end fitting 37 to the composite pipe 31. The collar 33 also has a lifting eye 30. FIG. 5 illustrates a cross-sectional view of the components of FIG. 4. As can be seen in FIG. 5, the end fitting assembly 30 is similar to the end fitting assembly of FIG. 3 in that wedges 32 are placed around the exterior of the composite pipe 31. The wedges 32 have a narrow end away from the termination of the composite pipe 31 and a wide end adjacent to the termination. The end fitting 37 is similar to the stab hub of FIG. 3 in that a portion is inserted into the composite pipe 31 and one or more o-rings 39 provide a seal between the end fitting 37 and the interior surface of the composite pipe 31. The collar 33 is also similar to the collars of FIGS. 2 and 3 in that it has a narrow end away from the termination of the composite pipe 31 and a wider end adjacent to the termination. The combination of the widening wedges 32 and the widening collar 33 result in a complete assembly that has a widening outer diameter as one moves towards the termination of the composite pipe 31. The example end fitting assembly 30 of FIGS. 4 and 5 suffers from the same limitations as the end fitting assemblies of FIGS. 2 and 3 in that the wider outer diameter at the termination of the composite pipe 31 limits its usefulness for pipe-in-pipe assemblies.

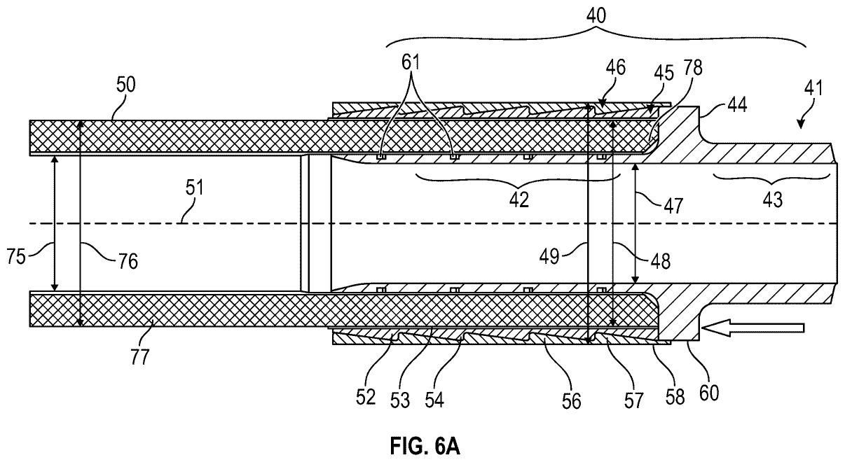

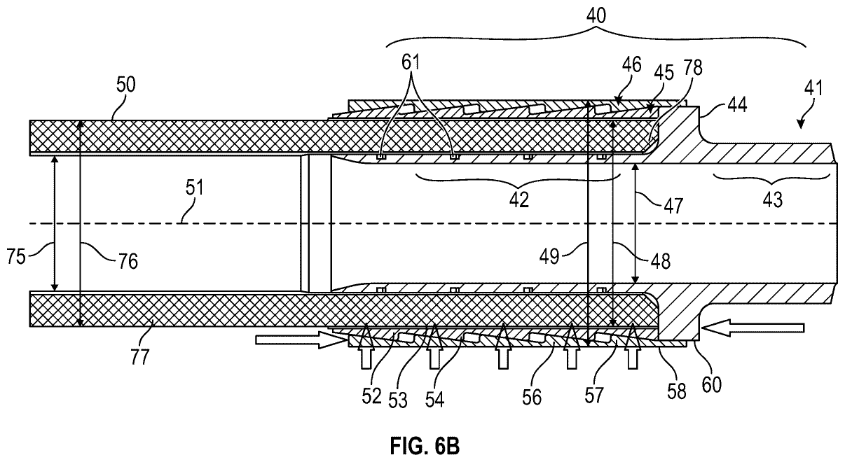

In view of the limitations with the prior art end fitting assemblies illustrated in FIGS. 1 through 5, there is a need for an improved end fitting assembly as illustrated in FIG. 6. FIGS. 6A and 6B provide a cross-sectional illustrations of an improved end fitting assembly 40 attached to a composite pipe 50. It should be understood that the end fitting assembly 40 and the composite pipe 50 are merely illustrative examples and in alternate embodiments the end fitting assembly 40 and the composite pipe 50 can have different or additional features. The example composite pipe 50 comprises a cylindrical pipe wall 77 defining an inner bore with an axis 51 that passes along the longitudinal center of the pipe 50. The pipe wall 77 defines an inner diameter 75 and an outer diameter 77 of the composite pipe 50. The half difference between the outer diameter 76 and the inner diameter 75 is the thickness of the pipe wall 77. In the example composite pipe 50 of FIGS. 6A and 6B, the pipe has coatings on the inner and outer surface, however, such coatings are not required. The end of the composite pipe 50 is referred to as the termination 78.

As will be explained further below, FIG. 6A illustrates the end fitting assembly 40 in a first position and FIG. 6B illustrates the end fitting assembly 40 at a later point in time in a second position. The following description will refer to both FIGS. 6A and 6B. At the termination 78 of the composite pipe 50, an end fitting 41 is inserted into the composite pipe 50. The end fitting 41 comprises a socket portion 42, a connector portion 43, and a stop 44. The socket portion 42, the connector portion 43, and the stop 44 can be forged or molded to form the end fitting 41 so that the end fitting is a single integrated component. The end fitting 41 has an inner diameter 47 that is constant along the length of the end fitting 41. In the example end fitting 41 of FIGS. 6A and 6B, the connector portion 43 has a thicker wall than the socket portion 42 because the connector portion 43 connects to other components and provides structural stability. Additionally, as illustrated in the example of FIGS. 6A and 6B, the end of the connector portion 43 that is farther from the stop 44 can have a beveled shape to facilitate welding connections to other end fittings, bulkheads, flowline end terminations, or other equipment. The central longitudinal axis of the end fitting 41 coincides with axis 51.

The socket portion 42 of the end fitting 41 is inserted into the composite pipe 50 until the stop 44 abuts against the termination 78 as shown in FIG. 6. O-rings 61 can be positioned between the external surface of the socket portion 42 and the inner surface of the pipe wall 77 to provide a sealing interface. The connector portion 43 extends from the socket portion 42 and the stop 44 so that it extends from the termination 78 of the composite pipe 50 when the socket portion 42 is completely inserted into the composite pipe 50.

Before the end fitting 41 is inserted into the composite pipe 50, the collar 46 and at least two wedges 45 are pre-assembled. That is, first, at least two wedges 45 are placed along the inner surface of the collar (preferably in opposing positions to balance loading on the wedges), and second, the combined assembly of the collar with the at least two wedges is placed around the external surface of the composite pipe 50 adjacent to the termination 78. In the example illustrated in FIGS. 6A and 6B, 12 wedges are placed about the inner surface of the collar 46 wherein each of the 12 wedges extends for 30 degrees about the inner circumference of the collar 46 so that when the 12 wedges are in place they cover the entire inner circumference of the collar 46 and, when inserted onto the composite pipe 50 the wedges 45 encircle the composite pipe 50. While 12 30-degree wedges are used in the example illustrated in FIGS. 6A and 6B, it should be understood that in alternate embodiments other configurations for the wedges can be used. In certain alternate embodiments, the wedges can have other angular dimensions such that 6 60-degree wedges can be used or 4 90-degree wedges can be used. In yet other alternate embodiments, a fewer number of wedges can be used so that they are spaced apart and do not completely encircle the composite pipe. For example, 6 30-degree wedges or 3 60-degree wedges could be placed at spaced apart positions (preferably equidistantly from each other) within the collar 46 and about the circumference of the composite pipe.

The at least two wedges used in the end fitting assemblies of this disclosure include a series of wedge cone sections on the outer surface and along the length of the wedges. As illustrated in the example of FIGS. 6A and 6B, the series of wedge cone sections provide a series of sloped steps along the outer surface of the wedges. The inner surface of the wedge that directly contacts the external surface of the inner composite pipe can be engineered to a particular texture that suits a project's requirements. In the example illustrated in FIGS. 6A and 6B, each wedge has 5 wedge cone sections, such as wedge cone section 52, along the outer surface of the wedge. In alternate embodiments, the wedge can have a fewer or greater number of wedge cone sections. As further indicated in FIGS. 6A and 6B, each wedge cone section has a wedge thin cone end 53 and a wedge thick cone end 54. As described further below, the wedge cone sections engage similar features on the collar resulting in a compression force on the composite pipe 50 that holds the end fitting assembly 40 in place.

After the collar 46 with the wedges 45 positioned therein are in place on the external surface of the composite pipe 50, the socket portion 42 of the end fitting 41 is inserted into the composite pipe 50. When the socket portion 42 is completely inserted, the stop 44 engages the termination 78 of the composite pipe 50 as well as the wedges 45 and collar 46 positioned at the termination as illustrated in FIG. 6A. FIG. 6A shows the first position of the collar 46. Next, as illustrated in FIG. 6B, the collar 46 is forced towards the stop 44 and the connector portion 43 with a clamping force as indicated by the horizontal arrow of FIG. 6B. FIG. 6B shows the collar 46 in a second position after the clamping force has been applied and the collar 46 has moved towards the stop 44 and the connector portion 43.

The collar used in the end fitting assemblies of this disclosure includes a series of collar cone sections on the inner surface of the collar along its length. As illustrated in the example of FIGS. 6A and 6B, the series of collar cone sections provide a series of sloped steps along the inner surface of the collar. In the example of FIGS. 6A and 6B, the collar cone sections extend about the entire 360-degree inner circumference of the collar 46. However, it alternate embodiments, the series of collar cone sections may only cover portions of the inner circumference of the collar. The outer circumference of the collar is preferably smooth. In the example illustrated in FIGS. 6A and 6B, the collar has 5 collar cone sections, such as collar cone section 56, along the inner length of the collar. In alternate embodiments, the collar can have a fewer or greater number of collar cone sections. As further indicated in FIGS. 6A and 6B, each collar cone section has a collar thin cone end 58 and a collar thick cone end 57.

As the cone sections of the collar 46 are forced further onto the cone sections of the wedges 45 by the clamping force, the collar moves from the position shown in FIG. 6A to the position shown in FIG. 6B. As the collar 46 is moved by the clamping force, the wedges 45 remain in place while the collar 46 moves towards the connector portion 43 and the collar thick cone ends of each collar cone section move toward the wedge thick cone ends of each wedge cone section creating a compression force directed inward toward the composite pipe 50, as indicated by the arrows pointing towards the center of the composite pipe 50 in FIG. 6B. The compression force secures the end fitting assembly 40 onto the composite pipe 50. While not a requirement, in certain embodiments the collar can be made from a high strength steel, while the wedges can be made from a softer carbon steel. Once the collar 46 is in the position shown in FIG. 6B, a weld 60 can be applied to secure the collar 46 to the outer circumferential surface of the stop 44 as illustrated in FIG. 6B. In other embodiments, securing means other than a weld, such as a dowel or other type of fastener, can be used to secure the collar 46 to the outer circumferential surface of the stop 44. As yet another example, threads on the inner surface of the collar 46 can mate with threads on the outer circumferential surface of the stop 44 to secure the collar 46 to the stop 44. In this way, the end fitting assembly 40 is simpler than the more complex end fitting assemblies of the prior art because it does not require a locking ring or other flanges and fasteners as illustrated in FIGS. 1-5.

The series of wedge cone sections and collar cone sections are an improvement over the prior art because they allow the end fitting assembly 40 to have a smaller outer diameter. Preferably, the wedges 45 have a constant inner diameter 48 along the length of the wedges in the direction of the axis 51. Similarly, it is preferred that the collar 46 has a constant outer diameter 49 along the length of the collar in the direction of the axis 51. In contrast to the widening diameters of the pipe wall, collet, collar, or wedges of the prior art, the outer diameter of the collar 46 of the end fitting assembly 40 does not increase as one moves towards the termination 78 of the composite pipe 50. Accordingly, the more compact diameter of the end fitting assembly of FIGS. 6A and 6B allows insertion of the composite pipe 50 and end fitting assembly 40 through an outer pipe in a pipe-in-pipe assembly.

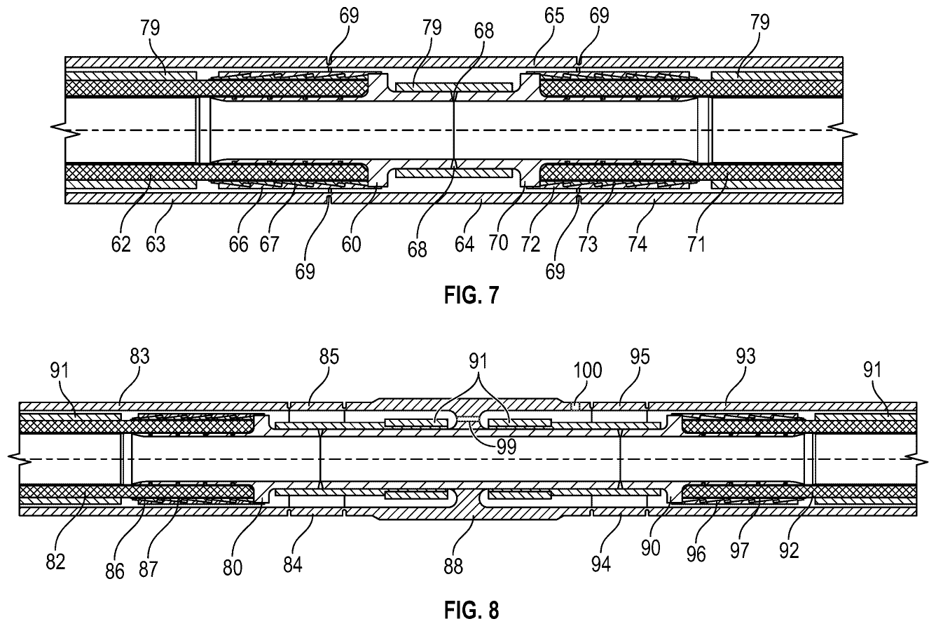

Referring now to FIGS. 7-9, certain examples of pipe-in-pipe assemblies in accordance with the embodiments of this disclosure are illustrated. The examples of FIGS. 7-9 illustrate how a more compact end fitting facilitates insertion of the composite pipe and end fitting within an outer pipe of a pipe-in-pipe assembly. While example pipe-in-pipe assemblies are illustrated in FIGS. 7-9, it should be understood that the assembled composite pipe 50 and end fitting assembly 40 illustrated in FIG. 6B can have stand-alone applications where it is not inserted into another outer pipe to form a pipe-in-pipe assembly. Some applications may call for only the composite pipe 50 and end fitting assembly 40 without an outer pipe.

In FIG. 7, a composite pipe 62 has an attached end fitting assembly similar to that described in connection with FIG. 6. The end fitting assembly attached to composite pipe 62 comprises an end fitting 60, at least two wedges 67, and a collar 66. The composite pipe 62 and its attached end fitting assembly have been pulled through outer pipe 63 to form a first pipe-in-pipe assembly. Similarly, on the right side of FIG. 7 a second pipe-in-pipe assembly is formed from a composite pipe 71 and end fitting assembly inserted into an outer pipe 74. When configured in a pipe-in-pipe assembly as illustrated in FIGS. 7-10, the composite pipe can also be referred to as an inner composite pipe. The end fitting assembly of the second pipe-in-pipe assembly is similar to the end fitting assembly described in connection with FIG. 6 and comprises an end fitting 70, a collar 72, and at least one wedge 73. The first and second pipe-in-pipe assemblies can be joined by welding together end fitting 60 and end fitting 70 as indicated by welds 68. Optionally, as illustrated in FIG. 7, insulation 79 can be placed around the composite pipe 62 and composite pipe 71 before they are inserted into their respective outer pipes so that the insulation is positioned in the annulus between the inner composite pipes and the outer pipes. Additionally, insulation 79 also can be placed around the connector portions of end fitting 60 and end fitting 70.

Next, shells 64 and 65 can be placed around the end fittings 60 and 70. Welds 69 can join the half shells 64 and 65 to the outer pipes 63 and 74 thereby completing the system of two joined pipe-in-pipe assemblies. Although half shells are illustrated in FIGS. 7-9, it should be understood that these are non-limiting examples and that the shell portions of the outer pipe can have a variety of shapes. Additionally, in other example embodiments, the shells can be omitted and the outer pipe portions of each pipe-in-pipe assembly can be joined directly by a single orbital weld. The compact design of the end fitting assemblies, as shown in FIG. 7, facilitates joining of the two pipe-in-pipe assemblies and allows the joined pipe-in-pipe assemblies to be reeled onto a reel for transport and deployment in a pipeline.

FIG. 8 illustrates a joining of two pipe-in-pipe assemblies similar to FIG. 7, but with an intermediate bulkhead 88 positioned between the two pipe-in-pipe assemblies. A composite pipe 82 has an attached end fitting assembly similar to that described in connection with FIG. 6. The end fitting assembly attached to composite pipe 82 comprises an end fitting 80, at least two wedges 87, and a collar 86. The composite pipe 82 and its attached end fitting assembly have been pulled through outer pipe 83 to form a first pipe-in-pipe assembly. Similarly, on the right side of FIG. 8 a second pipe-in-pipe assembly is formed from a composite pipe 92 and end fitting assembly inserted into an outer pipe 93. The end fitting assembly of the second pipe-in-pipe assembly is similar to the end fitting assembly described in connection with FIG. 6 and comprises an end fitting 90, a collar 96, and at least two wedges 97. The first and second pipe-in-pipe assemblies can be joined to opposite ends of the bulkhead 88 by inner welds 89 at the points where the end fitting 80 meets the bulkhead and where end fitting 90 meets the bulkhead. Similar to the previous explanation in connection with FIG. 7, insulation 91 can be positioned in the annulus between the inner composite pipe sections and the outer pipe sections, as well as within the annulus formed within the bulkhead.

Next, shells 84 and 85 can be placed around the end fitting 80 and welded, thereby joining the outer pipe 83 to one end of the bulkhead. Similarly, shells 94 and 95 can be placed around end fitting 90 and welded, thereby joining the outer pipe 93 to the opposite end of the bulkhead. Similar to the previous explanation in connection with FIG. 7, in other example embodiments, the shells can be omitted and the outer pipe portions of each pipe-in-pipe assembly can be joined directly to the bulkhead by a single orbital weld. Accordingly, the compact end fitting assemblies of the two pipe-in-pipe assemblies of FIG. 8 facilitate joining to a bulkhead.

The example bulkhead 88 of FIG. 8 also includes an optional external port 100 and an optional internal port 99. The external port 100 is located in the outer wall of the bulkhead 88 and can be opened and closed to provide access to the interior of the bulkhead. The internal port 99 is located in an inner annular wall of the bulkhead 88 and can be opened and closed to provide fluid communication along the annulus between the pipe-in-pipe assembly on the left side of the figure and the pipe-in-pipe assembly on the right side of the figure. As one example, the external port 100 and the internal port 99 can be used to evacuate fluids (e.g., condensation, gasses) that accumulate in the annulus of the pipeline. As another example, the external port 100 can be accessed by an undersea vehicle (e.g., a ROV or AUV) in order to perform maintenance on the pipeline.

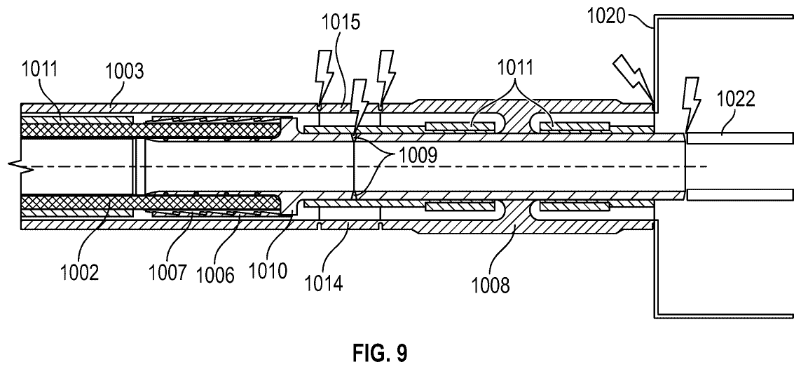

FIG. 9 illustrates a pipe-in-pipe assembly attached to a bulkhead 1008 and the bulkhead 1008 is attached to a flowline end termination 1020. A composite pipe 1002 has an attached end fitting assembly similar to that described in connection with FIG. 6. The end fitting assembly attached to composite pipe 1002 comprises an end fitting 1010, at least two wedges 1007, and a collar 1006. The composite pipe 1002 and its attached end fitting assembly have been pulled through outer pipe 1003 to form a pipe-in-pipe assembly. Similar to the assembly in FIG. 8, the pipe-in-pipe assembly is attached to a bulkhead 1008. Specifically, the end fitting 1010 is attached to the bulkhead 1008 by inner welds 1009 at the points where the end fitting 1010 meets the bulkhead 1008. Similar to the previous explanation in connection with FIG. 7, insulation 1011 can be positioned in the annulus between the inner composite pipe and the outer pipe, as well as within the annulus formed within the bulkhead.

Next, shells 1014 and 1015 can be placed around the end fitting 1010 and welded, thereby joining the outer pipe 1003 to one end of the bulkhead 1008. Similar to the previous explanation in connection with FIG. 7, in other example embodiments, the shells can be omitted and the outer pipe 1003 of the pipe-in-pipe assembly can be joined directly to the bulkhead 1008 by a single orbital weld. At the opposite end of the bulkhead 1008, the bulkhead is welded to a flowline end termination (“FLET”) at the FLET piping 1022 and at the outer FLET structure 1020. Accordingly, the compact end fitting assembly of the pipe-in-pipe assembly can be attached to an FLET.

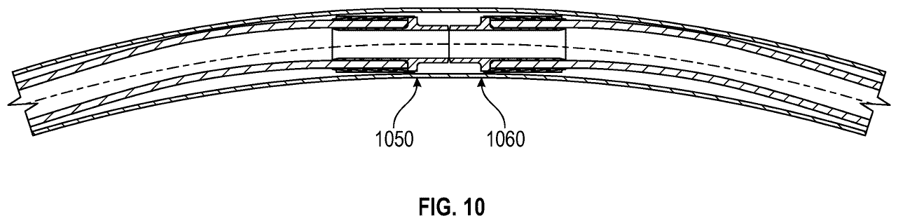

FIG. 10 illustrates the advantage in bending flexibility provided by the more compact end fitting assembly of the present disclosure. Specifically, FIG. 10 illustrates a pipe system comprising two joined pipe-in-pipe assemblies joined by end fitting assembly 1050 and end fitting assembly 1060 in a manner similar to that described previously in FIG. 7. Additionally, the pipe system in FIG. 10 is bent in a manner that it would be bent when the pipe system is reeled onto a reel for transport and deployment of the pipe system. The compact diameter of the end fitting assemblies 1050 and 1060 allows for the bending necessary to reel the pipe system onto a reel.

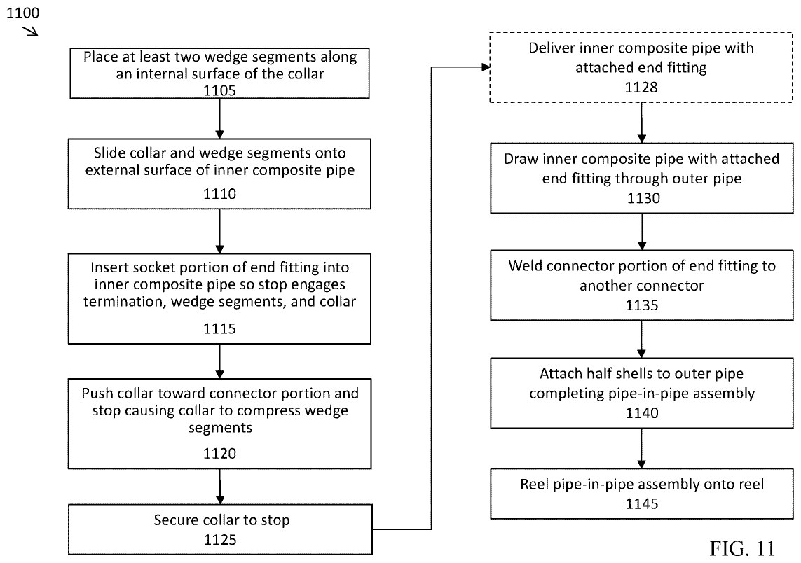

Referring now to FIG. 11, an example 1100 is illustrated of a method for assembling an inner composite pipe and end fitting assembly for a pipe-in-pipe assembly. One of the advantages of the compact end fitting assembly of the present disclosure is that it facilitates fabrication of pipe systems at onshore locations as well as offshore locations for deployment in subsea pipelines. Additionally, the compact end fitting assembly of the present disclosure can be used in any pipe-in-pipe assembly, including (i) an assembly with a composite inner pipe and a steel outer pipe, (ii) an assembly with a composite inner pipe and a composite outer pipe, and (iii) retrofitting existing pipelines by inserting composite pipe into existing steel pipe. Accordingly, it should be understood that method 1100 is a non-limiting example and in alternate embodiments certain operations of method 1100 may be modified, combined, performed in parallel, or omitted.

In operation 1105, at least two wedges are placed along an inner surface of a collar as described previously in connection with FIGS. 6A and 6B. Next, in operation 1110, beginning with a composite pipe without an end fitting, the collar with the at least two wedges positioned therein are fed onto the external surface of the composite pipe. The composite pipe can be referred to as the inner composite pipe if it will later be inserted into a pipe-in-pipe assembly. Next, in operation 1115, a socket portion of an end fitting is inserted into the termination of the composite pipe similar to the arrangement illustrated in FIG. 6A. With the socket portion completely inserted into the composite pipe, the stop of the end fitting engages the composite pipe's termination, as well as the wedges and the collar located about the external surface of the composite pipe's termination. In operation 1120, the collar, which was placed onto the composite pipe in operation 1110, is pushed, with a clamping force, further onto the at least two wedges and toward the stop and the connector portion of the end fitting. The clamping force causes the collar cone sections to compress the wedge cone sections resulting in compression of the at least two wedges into the inner composite pipe. In operation 1125, the collar is secured to the stop of the end fitting with a weld or other securing means.

With the end fitting assembly secured to the composite pipe, the composite pipe now can be used advantageously for a variety of applications, including retrofitting existing pipe or for use in fabricating new pipe-in-pipe assemblies. In some cases, the composite pipe with the attached end fitting assembly can be reeled onto a reel and shipped to other onshore or offshore locations for fabrication of a pipe-in-pipe assembly. In other cases, the fabrication of the pipe-in-pipe assembly can occur at the same site that the end fitting assembly was attached. Accordingly, operation 1128 is shown in broken lines to indicate it is an optional step.

Referring to operation 1130, the fabrication of the pipe-in-pipe assembly begins with drawing the inner composite pipe with the attached end fitting assembly through the outer pipe. Next, in operation 1135, the connector portion of the end fitting assembly is welded to another connector. The other connector can be another connector of an end fitting assembly of another pipe-in-pipe assembly. Alternatively, the other connector could be a connector of another structure such as a bulkhead. In operation 1140, the shells are welded to the outer pipe thereby enclosing the end fitting assembly attached to the inner composite pipe. Alternatively, in certain examples the shells can be omitted and the outer pipe can be welded directly to another outer pipe or structure. Lastly, in operation 1145, the pipe-in-pipe assembly can be reeled onto a reel for transporting and shipping the pipe-in-pipe assembly. As an alternative to reeling, the pipe-in-pipe assembly may be directly deployed as part of a pipeline. Accordingly, example method 1100 further illustrates the advantages of the compact end fitting assembly disclosed herein.

For any figure shown and described herein, one or more of the components may be omitted, added, repeated, and/or substituted. Additionally, it should be understood that in certain cases components of the example systems can be combined or can be separated into subcomponents. Accordingly, embodiments shown in a particular figure should not be considered limited to the specific arrangements of components shown in such figure. Further, if a component of a figure is described but not expressly shown or labeled in that figure, the label used for a corresponding component in another figure can be inferred to that component. Conversely, if a component in a figure is labeled but not described, the description for such component can be substantially the same as the description for the corresponding component in another figure.

With respect to the example methods described herein, it should be understood that in alternate embodiments, certain steps of the methods may be performed in a different order, may be performed in parallel, or may be omitted. Moreover, in alternate embodiments additional steps may be added to the example methods described herein. Accordingly, the example methods provided herein should be viewed as illustrative and not limiting of the disclosure.

Terms such as “first”, “second”, “top”, “bottom”, “side”, “distal”, “proximal”, and “within” are used merely to distinguish one component (or part of a component or state of a component) from another. Such terms are not meant to denote a preference or a particular orientation, and are not meant to limit the embodiments described herein. In the example embodiments described herein, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

The terms “a,” “an,” and “the” are intended to include plural alternatives, e.g., at least one. The terms “including”, “with”, and “having”, as used herein, are defined as comprising (i.e., open language), unless specified otherwise.

Various numerical ranges are disclosed herein. When Applicant discloses or claims a range of any type, Applicant's intent is to disclose or claim individually each possible number that such a range could reasonably encompass, including end points of the range as well as any sub-ranges and combinations of sub-ranges encompassed therein, unless otherwise specified. Numerical end points of ranges disclosed herein are approximate, unless excluded by proviso.

Values, ranges, or features may be expressed herein as “about”, from “about” one particular value, and/or to “about” another particular value. When such values, or ranges are expressed, other embodiments disclosed include the specific value recited, from the one particular value, and/or to the other particular value. Similarly, when values are expressed as approximations, by use of the antecedent “about,” it will be understood that the particular value forms another embodiment. It will be further understood that there are a number of values disclosed therein, and that each value is also herein disclosed as “about” that particular value in addition to the value itself. In another aspect, use of the term “about” means ±20% of the stated value, ±15% of the stated value, ±10% of the stated value, ±5% of the stated value, ±3% of the stated value, or ±1% of the stated value.

Although embodiments described herein are made with reference to example embodiments, it should be appreciated by those skilled in the art that various modifications are well within the scope of this disclosure. Those skilled in the art will appreciate that the example embodiments described herein are not limited to any specifically discussed application and that the embodiments described herein are illustrative and not restrictive. From the description of the example embodiments, equivalents of the elements shown therein will suggest themselves to those skilled in the art, and ways of constructing other embodiments using the present disclosure will suggest themselves to practitioners of the art. Therefore, the scope of the example embodiments is not limited herein.

What is claimed is:

1. An end fitting assembly for a composite pipe, the end fitting assembly comprising:
a socket portion having a cylindrical shape and comprising a socket internal surface and a socket external surface, the socket portion configured to fit within an end of the composite pipe;
a connector portion having a cylindrical shape and comprising a connector internal surface and a connector external surface, the connector portion extending from the socket portion;
a stop located between the socket external surface and the connector external surface;
a collar that attaches to the stop, the collar having a cylindrical shape; and
at least two wedges that are positioned between an external surface of the composite pipe and a collar internal surface,
wherein each wedge of the at least two wedges comprises a series of wedge cone sections along an outer surface of the at least two wedges, and
wherein the collar internal surface comprises a series of collar cone sections.

2. The end fitting assembly of claim 1, wherein the collar has a constant outer diameter.

3. The end fitting assembly of claim 1, wherein the end fitting assembly is configured to attach to one of: another end fitting assembly, a bulkhead, and a flowline end termination.

4. The end fitting assembly of claim 1, wherein when the collar and the at least two wedges are fitted around the external surface of the composite pipe and, when the composite pipe is inserted into an outer pipe to form a pipe-in-pipe assembly, an external surface of the collar is parallel to an internal surface of the outer pipe of the pipe-in-pipe assembly.

5. The end fitting assembly of claim 1, wherein the at least two wedges surround the external surface of the composite pipe.

6. The end fitting assembly of claim 1, wherein when the collar is moved toward the stop and the connector portion, the collar cone sections compress the wedge cone sections thereby compressing the composite pipe.

7. The end fitting assembly of claim 1, wherein, when a clamping force is applied to the collar toward the stop and the connector portion, a thick cone end of each collar cone section is moved toward a thick cone end of each wedge cone section.

8. The end fitting assembly of claim 1, wherein the collar attaches to an outer circumferential surface of the stop by one of: a weld, a dowel, and threads.

9. A pipe-in-pipe assembly comprising:
an outer pipe;
an inner composite pipe disposed within the outer pipe;
an end fitting assembly attached to a termination of the inner composite pipe, wherein the end fitting assembly comprises:
a socket portion having a cylindrical shape and comprising a socket internal surface and a socket external surface, the socket portion disposed within the termination of the inner composite pipe;
a connector portion having a cylindrical shape and comprising a connector internal surface and a connector external surface, the connector portion extending from the socket portion and the termination of the inner composite pipe;
a stop located between the socket external surface and the connector external surface;
a collar attached to the stop, the collar having a cylindrical shape; and
at least two wedges positioned between an external surface of the inner composite pipe and a collar internal surface,
wherein each wedge of the at least two wedges comprises a series of wedge cone sections along an outer surface of the at least two wedges, and
wherein the collar internal surface comprises a series of collar cone sections.

10. The pipe-in-pipe assembly of claim 9, wherein the collar has a constant outer diameter that is less than an inner diameter of the outer pipe.

11. The pipe-in-pipe assembly of claim 9, wherein the pipe-in-pipe assembly is configured to attach to one of: another pipe-in-pipe assembly, a bulkhead, and a flowline end termination.

12. The pipe-in-pipe assembly of claim 11, wherein when the pipe-in-pipe assembly is attached to another pipe-in-pipe assembly, the pipe-in-pipe assembly and the other pipe-in-pipe assembly can be reeled onto a spool.

13. The pipe-in-pipe assembly of claim 9, wherein the at least one wedge surrounds the external surface of the inner composite pipe.

14. The pipe-in-pipe assembly of claim 9, wherein when the collar is moved toward the stop and the connector portion, the collar cone sections compress the wedge cone sections thereby compressing the inner composite pipe.

15. The pipe-in-pipe assembly of claim 9, wherein when a clamping force is applied to the collar a thick cone end of each collar cone section is moved toward a thick cone end of each wedge cone section.

16. The pipe-in-pipe assembly of claim 9, wherein the pipe-in-pipe assembly is configured to be attached to a bulkhead, the bulkhead comprising an external port and an internal port providing access to an annulus of the pipe-in-pipe assembly.

17. A method for assembling an inner composite pipe and end fitting assembly for a pipe-in-pipe assembly, the method comprising:
placing at least two wedge segments along an internal surface of a collar;
sliding the collar with the at least two wedge segments onto an external surface of the inner composite pipe;
inserting a socket portion of an end fitting into a termination of the inner composite pipe, the socket portion inserted until a stop of the end fitting engages the termination, the at least two wedge segments and the collar, wherein the end fitting comprises a connector portion extending from the stop and extending from the socket portion and extending out of the termination of the inner composite pipe;
pushing the collar toward the stop and the connector portion causing the collar to compress the at least two wedges, the collar comprising a series of collar cone sections along a collar internal surface; and
securing the collar to the stop.

18. The method of claim 17, further comprising: drawing the end fitting and the inner composite pipe through an outer pipe until the connector portion of the end fitting extends from a termination of the outer pipe, wherein the inner composite pipe, the end fitting, and the outer pipe form the pipe-in-pipe assembly.

19. The method of claim 18, further comprising: reeling the pipe-in-pipe assembly onto a reel.

20. The method of claim 17, wherein when the collar is pushed onto the at least two wedges, the collar cone sections engage wedge cone sections along an outer surface of the at least two wedges thereby compressing the inner composite pipe.
